(19) United States
(12) Patent Application Publication
(10) Pub. No.: US 2015/0107192 A1
(43) Pub. Date: Apr. 23, 2015

(54) DISPENSING UNIT

(71) Applicant: Monolith GmbH Buerosysteme, Essen (DE)

(72) Inventor: Bernd Loibl, Klettgau (DE)

(21) Appl. No.: 14/259,328

(22) Filed: Apr. 23, 2014

(30) Foreign Application Priority Data
Apr. 29, 2013 (DE) 202013003963.9

(51) Int. Cl. B65H 35/00; B65B 67/08; B26D 1/10

(52) U.S. Cl. CPC B65H 35/004; B26D 1/105; B65H 35/0086; B65B 67/08
USPC 53/389.3; 83/614

(57) ABSTRACT

The invention relates to a dispensing unit for providing web material with a support wall and a movable opposite support wall including a cutting device including a cutting slide and a cutting blade fixated at the cutting slide and including a linear support at the opposite support wall, wherein the cutting slide includes an operating head and a slide base and the cutting blade extends between the operating head and the slide base, and wherein the support wall includes a recess which is configured so that it facilitates a movement of the cutting slide and the slide base is movable away from the recess when moving the opposite support wall.

### RELATED APPLICATIONS

This application claims priority from and incorporates by reference German utility model application 20 2013 003 963.9, filed on Apr. 29, 2013 which is incorporated in its entirety by this reference.

### FIELD OF THE INVENTION

The invention relates to a dispensing unit for providing web material.

### BACKGROUND OF THE INVENTION

Dispensing units of the general type recited supra are used for pulling off web material from a web material roll and for cutting a web material section from the pulled off portion. In particular paper or foil webs can be used which are useable for packaging purposes, for example as gift wraps. These are not dispensing units for bathroom applications which typically have complicated, partially motor driven mechanisms in order to provide the web material so that it can be handled.

Dispensing units are typically made from a roll support and a cutting device attached at a support wall. Both are associated with one another so that web material can be pulled off over the support wall from the web material roll that is inserted into the roll support. A cutting device facilitates cutting a web material section from the pulled off web material. Embodiments for simple dispensing units of this type can be derived from US 2004/0040429 A1, U.S. Pat. No. 5,758,559 A, EP 1 808 394 A1 and DE 60 2005 001 319 T2.

The cutting unit for dispensing units of this general type includes a cutting slide which is slideably supported in a slide support which extends transversal to a pull off direction of the web material. A pull off direction is a direction in which the web material can be pulled off from a web material roll that is received in the roll support. As apparent in particular from US 2004/0040429 A1 the cutting slide includes a guide base that engages the slide support and it includes an operating head provided for handling the cutting slide, wherein a fixed cutting blade with an edge or with two opposite edges for being useable in both sliding directions extends between the operating head and the support base. The slide support includes a support rail that is arranged at the support wall, wherein the support rail is configured in the form of grooved rails including undercuts. Therein the support base is supported so that it cannot be lifted out of the support rail transversal to an extension of the support rail, The cutting slide extends far enough from the support rail to that its cutting blade protrudes beyond the support rail and the support wall.

For a cutting process the cutting slide is moved to one end of the slide support. There the cutting slide is outside of the portion where web material is pulled off for preparing a cut. The pull off is performed so that the web material is pulled over the support wall and thus over the support rail far enough so that an appropriate web material section is on the other side of the cutting device with respect to web material roll. Then the cutting slide is moved along the support rail through respective handling of the operating head with the consequence that the cutting blade of the cutting slide cuts into the web material and cuts off the web material section.

The known dispensing devices of the type described supra are configured in a very simple manner mostly due to cost reasons but they have functional disadvantages. Thus, the support of the cutting slide only at the bottom side of the web material to be cut off is not particularly precise so that uneven cut edges are created. Furthermore an operator has to hold the web material taunt over the support wall in order to prevent an uneven cut or tearing of the web material. This, however is not easily feasible since an excessive pull on the web material would cause further pull off from the web material roll. Thus, operating the known dispensing units there has its problems and does not provide clean and straight cut edges.

U.S. Pat. No. 3,370,497 discloses a dispensing unit for providing web material in which the cutting slide of the cutting device is supported at an opposite support wall which is different from the previously cited dispensing units so that the opposite support wall is moveably supported so that it is moveable from a first position adjacent to the support wall into a second position that is remote from the support wall. The cutting slide includes a fixed cutting blade which protrudes beyond the side of the opposite support wall that is arranged opposite to the support wall and protrudes in a first position of the opposite support wall into a groove shaped recess in the support wall. In this dispensing unit there is a risk that an operator may get injured at the cutting blade when the opposite support wall is in the first position, in particular when web material is pulled off from the web material roll before cutting. Furthermore the inclined cutting edges of the cutting blade prevent the web material from sliding from the cutting blade, in particular when the cutting edges lose their sharpness after a while. This yields unsatisfactory cutting results.

### BRIEF SUMMARY OF THE INVENTION

Thus, it is an object of the invention to provide a dispensing unit including a roll support for receiving a web material roll so that the web material roll is rotatable, wherein the dispensing unit includes a support wall that is fixated at the dispensing unit, wherein the support wall is configured and arranged so that web material which is pulled off from a web material roll that is arranged in the roll support is pullable out of the dispensing unit in a pull off direction, wherein an opposite support wall is arranged opposite to the support wall, wherein the opposite support wall is movably supported so that it is movable from a first position adjacent to the support wall into a second position that is remote from the support wall, wherein a cutting device is associated with the support wall, wherein the cutting device includes a cutting slide with a fixated cutting blade, wherein the cutting device includes a slide support for the cutting slide that extends transversal to the pull off direction of the web material, wherein the slide support includes a linear support, wherein the linear support is arranged at the opposite support wall, wherein the cutting slide is supported by the linear support, wherein the cutting slide includes an operating head, wherein the operating head is slideably supported in the linear support, wherein the operating head protrudes from the opposite support wall on a side that is oriented away from the support wall, wherein the cutting blade is arranged at the cutting slide so that moving the cutting slide along the linear support separates a web material section from a web material arranged on the support wall, wherein the cutting blade protrudes beyond the side of the opposite support wall which side is opposite to the support wall, wherein the support wall includes a recess, so that precisely cut edges can be obtained in spite of simple handling and so that operators are protected against a contact with the cutting blade.

This object is achieved according to the invention through a dispensing unit with the following features.

the cutting slide has a slide base;

the cutting blade extends between the operating head and slide base;

the recess is used for receiving the slide base and configured so that it facilitates moving the cutting slide over an extension of the linear support and so that the slide base is moveable from a first position into a second position away from a recess when the opposite support wall is moved.

A core idea of the invention is to provide a cutting slide of a dispensing unit according to the invention in which the cutting slide is supported at the opposite support wall with a slide base so that the cutting blade extends between the operating head and slide base. The slide base functions as a protective cover for the cutting blade when the opposite support wall is moved into its second position or arranged in its second position. Through respective dimensioning it is prevented that an operator can come in contact with the cutting blade. It is appreciated that an overhang of the cutting blade beyond a bottom side of the opposite support wall should be kept as small as possible, e.g. should not amount to more than 2.5 mm. The slide base and the recess in the support wall are thus sized so that the slide base fits into the recess, on the other hand side so that the slide base is moveable out of the recess when moving the opposite support wall from its first position into its second position. The slide base does not only have a protective function, but additionally prevents a sliding of the web material when being cut.

In a configuration of the invention it is provided that the opposite support wall is pivotable from a first position into a second position and vice versa about an axis extending transversal to the pull off direction. A suspension of this type for the opposite support wall can be produced in a simple manner and provides a precise movement sequence. Side lobes connected with the support wall can be used for pivotable support of the opposite support wall, wherein the side lobes are provided at a face of the dispensing unit. Advantageously the opposite support wall shall be pivotable far enough into the second position so that it does not pivot back into the first position self acting, at least when the dispensing unit is placed on a horizontal plane. When pulling the web material from the web material roll it is not required to retain the opposite support wall in the second position.

A particularly simple embodiment of the dispensing unit is provided when the support wall forms part of a base plate of the dispensing unit on which the dispensing unit sits during use. For simple handling it is advantageous when the support wall extends in a substantially horizontal direction in particular in a portion of the cutting device.

In a particularly advantageous embodiment of the dispensing unit according to the invention the opposite support wall is moveably supported so that it contacts the support wall at least in portions in the first position where the opposite support wall is adjacent to the recess, namely advantageously so that a contact is provided on both sides of the support rail, in particularly over its entire length. Differently from a tight gap between the support wall and the opposite support wall this embodiment provides the option to clamp the web material pulled off into cutting position through moving the opposite support wall from the second position into the first position between both walls, wherein a slight pressure onto an outside of the opposite support wall in a direction towards the support wall already suffices. The clamping supports the web material in its position and prevents its movement transversal to its plane. As a result extremely clean and reproducible edges are cut. Web material scrap is reliably prevented.

In another embodiment of the invention it is provided that the operating head and the linear support reach behind one another so that the operating head is not movable transversal to the linear support and out of the linear support, in particular not in a direction of an outside of the opposite support wall. Thus, also a correct support of the cutting slide orthogonal to a plane of the web material to be cut shall be provided since also this facilitates generation of clean cut edges.

The linear support can have a support slot that is open towards the support wall, wherein the support slot is penetrated by a support bar of the operating head. For a simple configuration it is useful when the support slot extends opposite to the recess. Thus, the support bar can be configured so that is reaches behind the linear support at its end oriented towards the support wall so that movability of the cutting slide perpendicular to a plane of the web material is limited.

According to the invention it is furthermore provided that the linear support includes at least one support groove at a side of the opposite support wall which side is oriented away from the support wall, wherein a protrusion of the operating head engages the support groove. Also this is eventually used for an exact support of the operating head and thus of the cutting slide. It is appreciated that both sides of the linear support can be provided with support grooves of this type.

Another feature of the invention is that the linear support is configured at least at one end open or openable so that the cutting slide is removable from the linear support at the at least one end. It is appreciated that this portion should be outside of the pull off portion of the web material.

The roll receiver can be configured in a simple manner so that two opposite receiving lobes are provided for supporting faces of the inserted web material roll, wherein receiving bars that are oriented towards one another extend from the receiving lobes for circumferentially supporting the inserted web material roll. The receiving bars can extend over an entire width of the roll receiver. However, since web material rolls of this type have substantial intrinsic stiffness, in particular when the web material is rolled onto a core, it suffices for avoiding unnecessary material consumption when short receiving bars are provided at the receiving lobes, wherein only short receiving bars are provided at the receiving lobes, which receiving bars extend over a circumferential portion that suffices for support.

The receiving lobes are advantageously connected with the support wall, thus advantageously so that the receiving bars transition flush into the support wall, thus so that there is no step between the two of them. The support of the web material roll is enhanced when additional support protrusions are provided opposite to the receiving bars for circumferential support of the inserted web material roll. The extension of the receiving bars or support protrusions shall be dimensioned so that on the one hand side an exact support of the web material roll is provided when web material is pulled off, and on the other hand side so that only very little material has to be processed in order to support the web material roll. In any case it is useful to shape and arrange the receiving bars and support protrusions so that they envelop a correctly inserted web material roll circumferential on both sides, but at the most far enough so that at least in one position an insertion of the web material roll into the roll support is feasible without having to remove portions of the dispensing unit for this purpose.

A particular aspect of the present invention is that an adhesive tape dispenser is arranged at the dispensing unit through which an adhesive tape roll can be provided. Since dispensing units are almost exclusively used for providing web material for packaging purposes and in particular when wrapping gifts adhesive tapes are typically used that use a layer made from pressure sensitive adhesive, a connection of the dispensing unit and glue strip dispenser provides that a glue strip is always available during packing. The adhesive tape dispenser can be configured as usual, this means it can include an adhesive tape roll support for receiving an adhesive tape roll and a separation device typically configured as a saw tooth shaped serrated edge for separating a glue strip section from the glue strip roll. An advantageous location for the glue strip dispenser can be one of the faces of the dispensing unit wherein the attachment is advantageously provided so that the glue strip dispenser is also removable. This way the glue strip dispenser can also be used at another location. Advantageously the glue strip dispenser should be attachable at both faces.

### BRIEF DESCRIPTION OF THE DRAWINGS

The invention is described in more detail based on an embodiment with reference to drawing figures, wherein:

FIG. 1 illustrates a perspective view of the dispensing unit according to the invention with the opposite support wall in the first position;

FIG. 2 illustrates the dispensing unit according to FIG. 1 in the same perspective view, however with the opposite support wall in the second position and with an inserted web material roll; and

FIG. 3 illustrates a cross section in a vertical plane through the dispensing unit according to FIGS. 1 and 2 in a plane through the cutting slide and with opposite support walls in the first position and with an inserted web material roll.

### DETAILED DESCRIPTION OF THE INVENTION

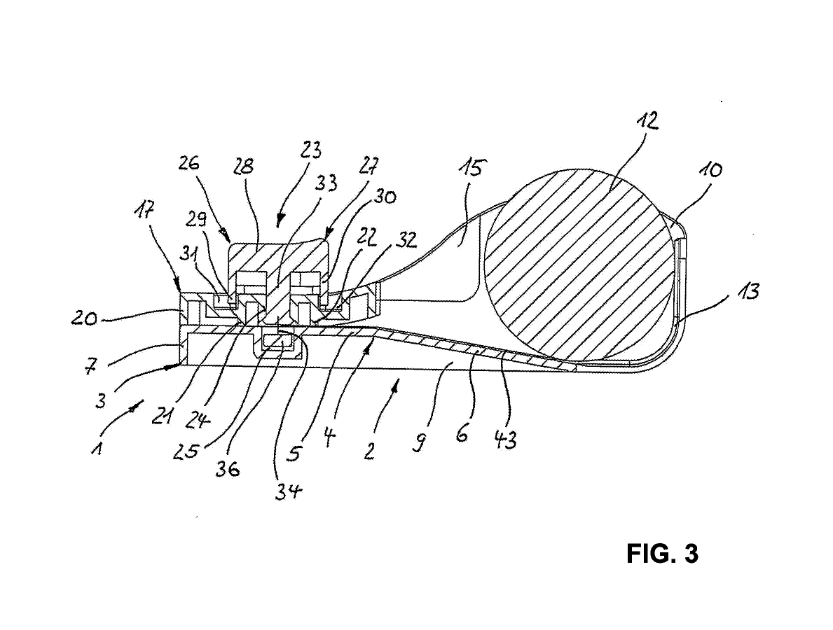

The dispensing unit 1 illustrated in the figures includes a shaped base element 2 with a base plate 3 with a rectangular planform. The topside of the base plate 3 is formed by a support plate 4 whose front portion includes a horizontally extending first section 5 and a second section 6 that slopes downward at a slant angle and adjoins in reward direction (cf. FIG. 3). At the front side and also at the two faces the base plate 3 is defined by termination bars 7, 8 extending downward from the support wall 4. At a bottom side of the support wall a plurality of vertical reinforcement ribs 9 (FIG. 3) are formed which extend parallel to face side termination bars 8. The dispensing unit 1 rests on lower face edges of the reinforcement ribs 9 and also on lower face edges of the termination bars 7, 8 when the dispensing unit is placed on a plane, for example a table top.

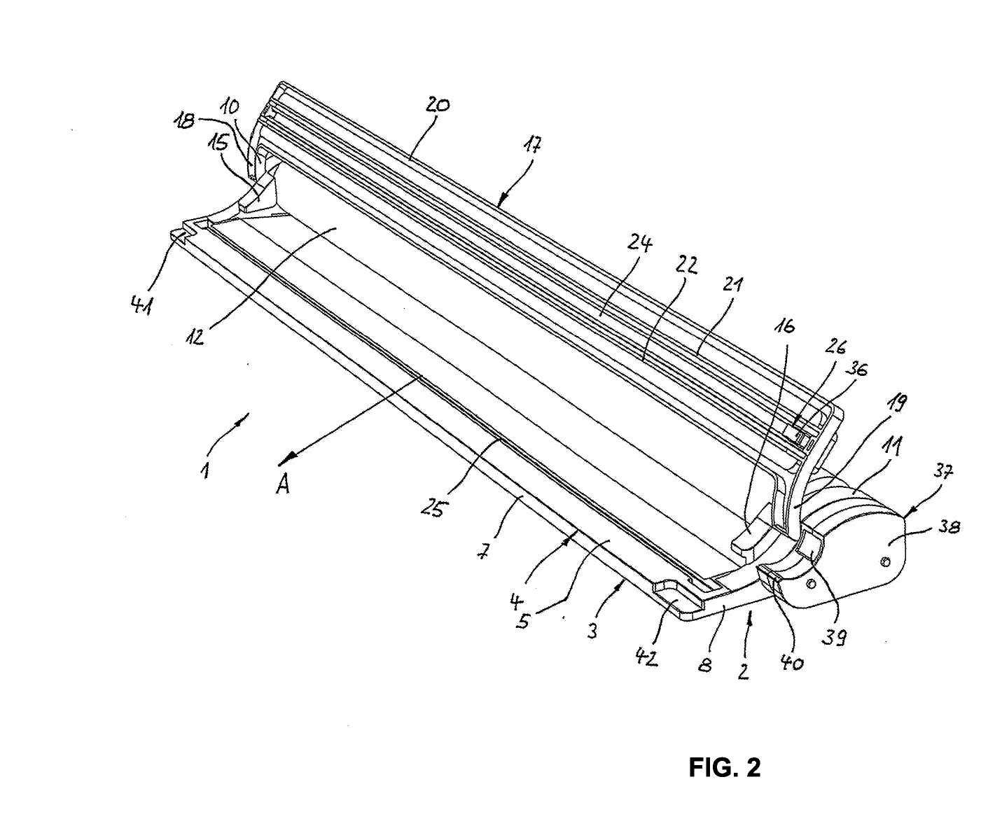

The face side termination bars 8 continue towards the back side of the dispensing unit 1 in formed side lobes 10, 11. They are depicted in mirror images. Together with the backward extending downward sloping section 6 of the support wall 4 the side lobes form a roll support for a web material roll 12 (FIGS. 2 and 3). The web material roll 12 is supported along its longitudinal extension at its bottom by the last portion of the second section 6. The faces of the web material roll 12 are supported by sides of the lateral walls 10, 11 that are oriented towards each other. Additionally receiving bars 13 that are oriented towards one another extend from both side lobes 10, 11, wherein the receiving bars join a rear edge of the support wall 4 in a flush manner and are bent upward. In the upper portion the receiving bars 13 support the web material roll 12 at its rear circumference (see FIG. 3). For support at the front side triangular support protrusions 15, 16 extend from the side lobes 10, 12 wherein the support protrusions enclose the web material roll 12 together with the receiving bar 13 at their ends as illustrated in FIG. 3. As also illustrated in FIG. 3 the receiving bars 13 on the one hand side and the support protrusions 15, 16 on the other hand side are offset so that a full web material roll 12 can be inserted into the roll support from above.

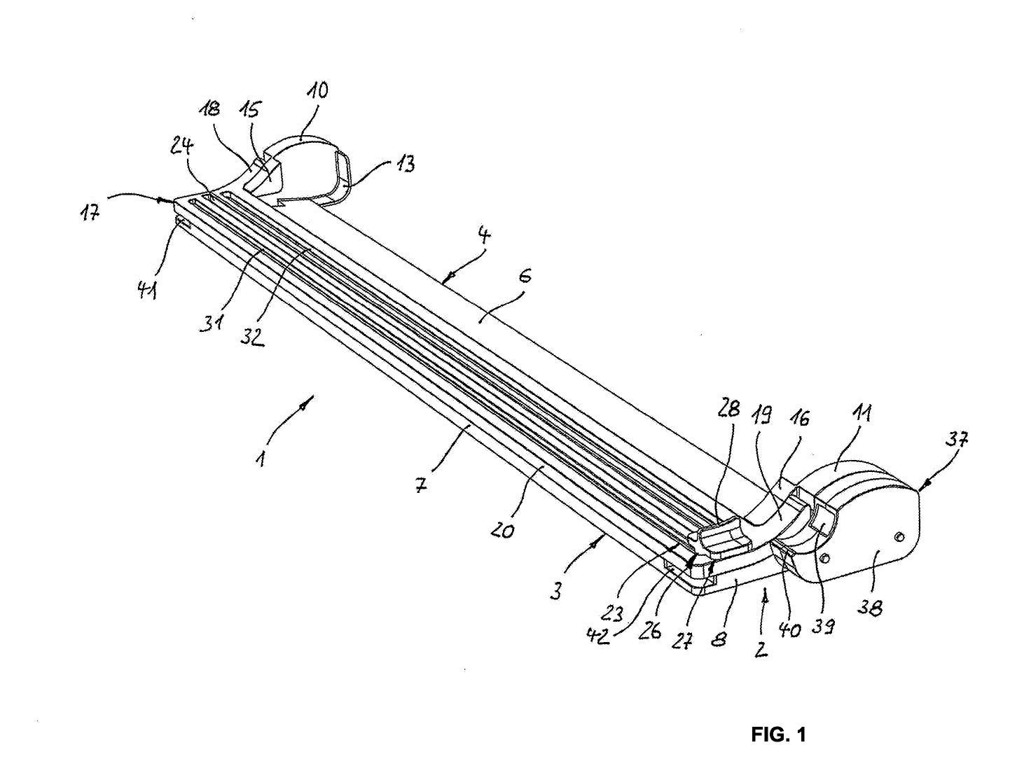

An opposite support wall 17 is pivotably supported about a pivot axis at outer sides of the support protrusions 15, 16 wherein the pivot axis extends in parallel with the front edge of the base plate 3 and thus perpendicular to the axis of the web material roll 12 and to its pull off direction (Arrow A in FIG. 2). Thus, pivot arms 18, 19 are formed at the opposite support wall 17 wherein the pivot arms enclose the support protrusions 15, 16 at an outside. In FIG. 1 the opposite support wall 17 is in a first position where it rests on the support wall 4 and in which the front side of the opposite support wall 17 terminates flush with the termination bar 7 of the base plate 3, so that as apparent from FIG. 3 the opposite support wall 17 completely covers the first horizontal section 5 of the support wall 4. In FIG. 2 the opposite support wall 17 is pivoted up into its second position, wherein the front faces of the side lobes 10, 11 are used as stops for the pivot arms 18, 19. The stops are arranged so far in the rear that the opposite support wall 17 in the second position illustrated in FIG. 2 is supported through its own weight and through its center of gravity so it contacts the sides lobes 10, 11, thus so that the opposite support wall doesn't pivot back again by itself.

The opposite support wall 17 has a termination bar 20 at its front side which forms a flush termination with the termination bar 7 of the base plate 9. Two offset clamping bars 21, 22 protrude at the bottom side of the opposite support wall 17 wherein the clamping bars extend parallel to one another over almost an entire width of the opposite support wall 17 and parallel to the termination bar 20. Its lower faces are at the same level as the faces of the termination bar 20. As apparent in particular from FIG. 3 the opposite support wall 17 contacts the support wall 4 in the first position with faces of the clamping bars 21, 22 and of the termination bar 20, this means the opposite support wall 17 is supported on a top side of the support wall 4 through the termination bar 20 and the clamping bars 21, 22 when the opposite support wall is in the first position.

A cutting device 23 is integrated into the support wall 4 and the opposite support wall 17 for cutting web material that is run between the two walls. The cutting device extends parallel to a front edge of the dispensing unit almost over an entire of width of the support wall 4 and of the opposite support wall 17. The cutting device 23 is essentially made from a support slot 24 extending in this direction and penetrating the opposite support wall 17, a groove recess 25 molded thereunder into the support wall 4 and having a rectangular cross section and open towards the support slot 24 and a cutting slide 26 protruding into the support slot 24 and the groove recess 25. Also the groove recess 25 extends almost over the entire width of the support wall 4. The support slot 24 and the groove recess 25 are arranged between the two clamping 21, 22, thus they are enclosed by the clamping bars.

The cutting slide 26 is essentially configured from three components. It includes an operating head 27 extending upwards beyond the opposite support wall 17 and having a handling bar 28 extending transversal to its movement direction predetermined by the support slot 24 and the groove recess 25. Below the handling bar 28 the operating head 27 includes downward extending protrusions 29, 30 which engage grooves 31, 32 respectively extending parallel to the support slot 24 and formed into the top side of the opposite support wall 17, so that the protrusions are proximal to groove walls that are adjacent to support slot 24, so that an additional support for the operating head 27 is provided. The operating head 27 includes a support bar 33 in its center wherein the support bar penetrates the support slot 24 and is configured wide enough so that it fills the support bar 33 besides a tolerance clearance so that the side walls of the support slot 24 support the support bar 33. At a lower free end support slot 24 and support bar 33 are widened, so that the support bar 33 reaches behind the support slot 24. This way it is not possible to lift the cutting slide 26 out of the support slot 24.

The support bar 33 terminates slightly above a topside plane of the support wall 4. There a fixated cutting blade 34 that extends in a vertical plane is molded into the support bar 33. The cutting blade 34 extends into the groove recess 25 and is connected there with a slight base 36 which has a rectangular cross section. The operating head 27 with the support bar 33, the cutting blade 34 and the slide base 36 form a rigid unit. The cutting blade 34 extends in the illustration of FIG. 3 perpendicular to the drawing plane and has sharp cutting edges at its front side and backside viewed in a direction of the support slot 24.

At a side of the side lobe 11 that is oriented towards a viewer of FIG. 1 and FIG. 2 an adhesive tape dispenser 37 is attached. The adhesive tape dispenser has a housing 38 into which an adhesive tape roll is inserted. At a front side the housing 38 has a dispensing opening 39 through which an adhesive tape strip that is pulled off from the roll can be pulled out. At the front edge of the housing 38 a serrated cutting edge is provided through which an adhesive tape section that is pulled out of the dispensing opening 39 can be cut off. An outer shape of the adhesive tape dispenser 37 is adapted to an outer shape of the side lobe 11.

In order to perform a cutting process the opposite support wall 17 is pivoted up from a first position illustrated in FIG. 1 into a second position illustrated in FIG. 2. Thus, reaching under the opposite support wall 17 is facilitated that recesses 41, 42 are formed into corners of the base plate 3. Pivoting the opposite support wall 17 lifts the slide base 36 out of the support groove 25. From the last cutting process there is still web material 43 on the support wall 4 up to the center of the support groove 25 (FIGS. 2 and 3). The web material 43 arranged at this location can now be gripped and pulled off over the support groove 25 and the front edge of the dispensing unit 1 in the desired length in pull off direction (Arrow A). Thereafter the opposite support wall 17 is folded down again into the first position (FIG. 1) wherein the cutting slide 26 is in the end position illustrated in FIG. 1 which is arranged outside of the pull off portion of the web material roll. The web material 43 is clamped between the topside of the support wall 4 and the faces of the clamping bars 21, 22 and of the termination bar 20 through a slight pressure on the opposite support wall 17 from above and thus fixated namely through the clamping bars 21, 22 proximal to cutting device 23 and thus of the cutting blade 34. Through moving the cutting slide 26 from the position illustrated in FIG. 1 to the other end of the cutting device 23 the cutting blade 34 engages the web material 43 with its cutting edge and cuts the web material section off that protrudes from the dispensing unit 1. The cut off web material section can then be removed from the dispensing unit 1 after lifting the opposite support wall 17 up again.

The dispensing unit one can not only be used to cut off web material 43 that is pulled off from a web material roll 12, but individual web material sheets can be cut in an analogous manner in that they are slid from behind on the support wall 4 in forward direction into the portion of the cutting device 23.

What is claimed is:

1. A dispensing unit for providing web material, comprising:
a dispensing unit including a roll support for receiving a web material roll so that the web material roll is rotatable,
wherein the dispensing unit includes a support wall that is fixated at the dispensing unit,
wherein the support wall is configured and arranged so that web material which is pulled off from a web material roll that is arranged in the roll support is pullable out of the dispensing unit in a pull off direction,
wherein an opposite support wall is arranged opposite to the support wall,
wherein the opposite support wall is movably supported so that it is movable from a first position adjacent to the support wall into a second position that is remote from the support wall,
wherein a cutting device is associated with the support wall,
wherein the cutting device includes a cutting slide with a fixated cutting blade,
wherein the cutting device includes a slide support for the cutting slide that extends transversal to the pull off direction of the web material,
wherein the slide support includes a linear support,
wherein the linear support is arranged at the opposite support wall,
wherein the cutting slide is supported by the linear support,
wherein the cutting slide includes an operating head,
wherein the operating head is slideably supported in the linear support,
wherein the operating head protrudes from the opposite support wall on a side that is oriented away from the support wall,
wherein the cutting blade is arranged at the cutting slide so that moving the cutting slide along the linear support separates a web material section from a web material arranged on the support wall,
wherein the cutting blade protrudes beyond the side of the opposite support wall which side is opposite to the support wall,
wherein the support wall includes a recess,
wherein the cutting slide includes a slide base,
wherein the cutting blade extends between the operating head and the slide base, and
wherein the recess is configured for receiving the slide base so that it facilitates movement of the cutting slide over an extension of the linear support and so that the slide base is movable away from the recess when the opposite support wall is moved from its first position into its second position.

2. The dispensing device according to claim 1,
wherein the opposite support wall is pivotable from a first position into a second position and vice versa about an axis extending transversal to the pull off direction,
wherein the support wall is enveloped by side lobes connected with the support wall,
wherein the opposite support wall is pivotably supported at the side lobes, and
wherein the opposite support wall is pivotable into the second position so that the opposite support wall does not pivot back into the first position by itself.

3. The dispensing unit according to claim 1, wherein the support wall forms a portion of a base plate of the dispensing unit.

4. The dispensing unit according to claim 1, wherein the support wall extends horizontally in particular in the portion of the cutting device.

5. The dispensing unit according to clam 1,
wherein the opposite support wall contacts the support wall at least in portions in the first position of the opposite support wall,
wherein the opposite support wall contacts the support wall in the first position of the opposite support wall on both sides of the recess over an entire length of the support wall.

6. The dispensing unit according to claim 1, wherein the operating head and the linear support reach behind one another so that the operating head is not movable out of the linear support transversal to a longitudinal extension of the linear support.

7. The dispensing unit according to claim 1,
wherein the linear support includes a support slot that is open towards the support wall,
wherein the support slot is penetrated by a support bar of the operating head, and
wherein the support slot extends opposite to the recess.

8. The dispensing unit according to claim 6, wherein the support bar is shaped so that it reaches behind the linear support at its end oriented towards the support wall.

9. The dispensing unit according to claim 1,
wherein the linear support includes at least one support groove at a side of the opposite support wall oriented away from the support wall, and
wherein a protrusion of the operating head engages the at least one support groove.

10. The dispensing unit according to claim 1, wherein the linear support is configured at least at one end open or openable so that the cutting slide is removable from the linear support at the at least one end.

11. The dispensing unit according to claim 1,
wherein the roll receiver includes two opposite receiving lobes for supporting faces of an inserted web material roll,
wherein receiving bars that are oriented towards one another extend from the receiving lobes for circumferentially supporting the inserted web material roll,
wherein the receiving lobes are connected with the support wall,
wherein the receiving bars transition flush into the support wall, and
wherein support protrusions are provided opposite to the receiving bars for circumferentially supporting the inserted web material roll.

12. The dispensing unit according to claim 11, wherein the receiving bars and the support protrusions are shaped and arranged so that they envelope the inserted web material roll circumferentially on both sides and facilitate inserting the web material roll into the roll support at least in one position.

13. The dispensing unit according to claim 1,
wherein an adhesive tape dispenser is arranged at the dispensing unit,
wherein the adhesive tape dispenser includes an adhesive tape roll support for receiving an adhesive tape roll and a separation device for separating an adhesive tape section from the adhesive tape roll,
wherein the adhesive tape roll dispenser is removably attached at a face of the dispensing device,
wherein the adhesive tape dispenser is attachable at both faces of the dispensing unit.
